(19) United States
(12) Patent Application Publication
(10) Pub. No.: US 2007/0012337 A1
(43) Pub. Date: Jan. 18, 2007

(54) IN-LINE METROLOGY FOR SUPERCRITICAL FLUID PROCESSING

(75) Inventors: Joseph T. Hillman, Williamsville, NY (US); Maximilian A. Biberger, Scottsdale, AZ (US)

Correspondence Address: WOOD, HERRON & EVANS, LLP (TOKYO ELECTRON), 2700 CAREW TOWER, 441 VINE STREET, CINCINNATI, OH, 45202, US

(73) Assignee: TOKYO ELECTRON LIMITED, Tokyo (JP)

(21) Appl. No.: 11/160,945

(22) Filed: Jul. 15, 2005

(51) Int. Cl. B08B 6/00; G06F 19/00

(52) U.S. Cl. 134/1.3; 700/121

(57) ABSTRACT

The system includes a metrology module coupled to a supercritical processing chamber, and the method includes positioning a substrate on a substrate holder in a metrology chamber, measuring a residue in at least one feature of the substrate, determining a supercritical cleaning process recipe based on the measured residue, positioning the substrate on a substrate holder in a supercritical processing chamber coupled to the metrology chamber, cleaning the substrate with a supercritical fluid using the determined supercritical cleaning process recipe, and removing the substrate from the supercritical processing chamber. The method may further include re-positioning the substrate in the metrology chamber, and measuring any remaining residue in at least one feature of the substrate.

### CROSS-REFERENCE TO RELATED APPLICATIONS

This patent application is related to commonly owned co-pending U.S. patent application Ser. No. 10/908,396 (Attorney Docket No. SSIT-100), filed May 13, 2005, entitled “Removal of Particles from Substrate Surfaces Using Supercritical Processing” which is hereby incorporated by reference in its entirety.

### FIELD OF THE INVENTION

This invention relates to the field of processing substrates in a supercritical processing system. More particularly, the present invention relates to the field of processing semiconductor wafers in a supercritical processing system coupled to a metrology module.

### BACKGROUND OF THE INVENTION

Carbon dioxide (CO₂) is an environmentally friendly, naturally abundant, non-polar molecule. Being non-polar, CO₂ has the capacity to dissolve in and dissolve a variety of non-polar materials or contaminates. The degree to which the contaminants found in non-polar CO₂ are soluble is dependant on the physical state of the CO₂. The four phases of CO₂ are solid, liquid, gas, and supercritical. The four phases or states are differentiated by appropriate combinations of specific pressures and temperatures. CO₂ in a supercritical state (SC—CO₂) is neither liquid nor gas but embodies properties of both. In addition, SC—CO₂ lacks any meaningful surface tension while interacting with solid surfaces, and hence, can readily penetrate high aspect ratio geometrical features more readily than liquid CO₂. Moreover, because of its low viscosity and liquid-like characteristics, the SC—CO₂ can easily dissolve large quantities of many other chemicals. It has been shown that as the temperature and pressure are increased into the supercritical phase, the solubility of CO₂ also increases. This increase in solubility has lead to the development of a number of SC—CO₂ processes.

One problem in semiconductor manufacturing is that the cleaning process sometimes does not completely remove photoresist residue and other residues and contaminants on the surface of the wafer. It would be advantageous to monitor the removal process to ensure the residues and/or contaminants have been removed from the features of the wafer.

What is needed is a method of and system for providing an improved method for monitoring a supercritical residue removal process.

### SUMMARY OF THE INVENTION

In accordance with the present invention, there is provided a method of and apparatus for processing a substrate having a patterned low-k layer thereon, the method comprising the steps of: positioning the substrate on a substrate holder in a metrology chamber; measuring a residue in at least one feature of the substrate; determining a supercritical cleaning process recipe based on the measured residue; positioning the substrate on a substrate holder in a supercritical processing chamber coupled to the metrology chamber; cleaning the substrate with a supercritical fluid using the determined supercritical cleaning process recipe; and removing the substrate from the supercritical processing chamber.

### BRIEF DESCRIPTION OF THE DRAWINGS

A more complete appreciation of various embodiments of the invention and many of the attendant advantages thereof will become readily apparent with reference to the following detailed description, particularly when considered in conjunction with the accompanying drawings, in which:

FIG. 1 shows an exemplary block diagram of a semiconductor processing system in accordance with an embodiment of the present invention;

FIG. 2 shows an exemplary block diagram of a processing system in accordance with embodiments of the invention;

FIG. 3 illustrates an exemplary graph of pressure versus time for a supercritical process step in accordance with an embodiment of the invention; and

FIG. 4 illustrates a flow chart of a method of performing a supercritical residue removal process on a substrate in accordance with embodiments of the present invention.

### DETAILED DESCRIPTION OF SEVERAL EMBODIMENTS

Advances in semiconductor process technology require that run-to-run (R2R) control be provided at the semiconductor processing equipment tool level. In order for the control of a supercritical processing system to be stable and robust, it is also necessary to provide fault detection and R2R control for the supercritical processing system. However, simple fault detection techniques are incompatible with R2R control and have the potential for generating frequent false alarms. An integrated system of advanced process control (APC) comprising data collection, data analysis, fault detection and classification (FDC), R2R control, automated design of experiments (DOE), statistical process control (SPC) charting, principle component analysis (PCA), multivariate analysis (MVA), and partial least squares (PLS) analysis can be used to provide accurate and reliable process control for supercritical processing systems used by the manufacturers of high performance semiconductor integrated circuits.

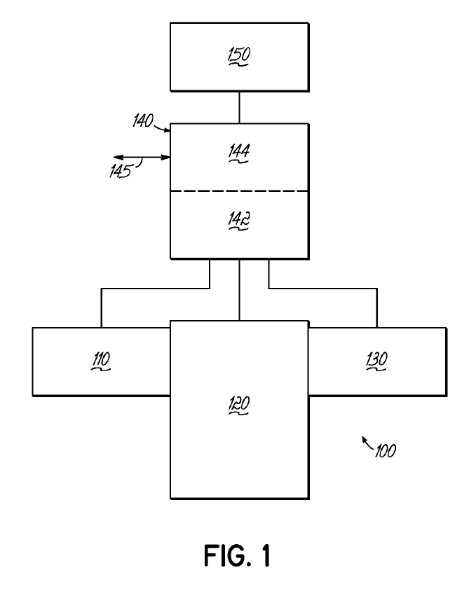

In the illustrated embodiment in FIG. 1, a semiconductor processing system 100 is shown that comprises a supercritical processing system 110, a transfer system 120 coupled to the supercritical processing system 110, a metrology module 130 coupled to the transfer system 120, and a system controller 140 coupled to the supercritical processing system 110, the transfer system 120, and the metrology module 130. In an alternate embodiment, the system may be configured differently. In addition, a manufacturing equipment system (MES) 150 is shown coupled to the system controller 140.

Setup and/or configuration information can be obtained for the supercritical processing system 110, the metrology module 130, and/or the system controller 140 from the MES 150. Operational/business rules can be used to establish a control hierarchy. For example, the supercritical processing system 110, the metrology module 130, and/or the system controller 140 can operate independently, or can be controlled to some degree by the MES 150. In addition, system level setup and/or configuration information can be determined by the supercritical processing system 110, the transfer system 120, the metrology module 130, and/or the system controller 140 when they are configured by the MES 150.

Operational/business rules can be used to specify the action taken for normal processing and the actions taken on exceptional conditions. Configuration screens can be used for defining and maintaining these and other rules. The rules can be stored and updated as required. Documentation and help screens can be provided on how to define, assign, and maintain the rules.

Operational/business rules can be used to determine when a process is paused and/or stopped, and what is done when a process is paused and/or stopped. In addition, rules can be used to determine when to change a process and how to change the process. Furthermore, a system controller 140 can use operational/business rules to control some tool level operations. In general, rules allow system and/or tool operation to change based on the dynamic state of the system.

MES 150 can monitor some system processes using data reported from the databases (not shown) associated with the semiconductor processing system 100. For example, the supercritical processing system 110, the transfer system 120, the metrology module 130, and/or the system controller 140 can generate data. Business rules can be used to determine which processes are monitored and which data is used. For example, the supercritical processing system 110, the transfer system 120, the metrology module 130, and/or the system controller 140 can independently collect data, or the data collection process can be controlled by the system controller 140 and/or MES 150. In addition, operational/business rules can be used to determine how to manage the data collection when a process is changed, paused, and/or stopped.

The MES 150 can provide run-time configuration information to the supercritical processing system 110, the transfer system 120, the metrology module 130, and/or the system controller 140. For example, APC settings, targets, limits, rules, and algorithms can be downloaded from the factory to the supercritical processing system 110, the transfer system 120, the metrology module 130, and/or the system controller 140 at or before run-time.

In FIG. 1, one supercritical processing system 110, one transfer system 120, one metrology module 130, and one system controller 140 are shown, but this is not required for the invention. The semiconductor processing system 100 can comprise any number of processing systems, transfer systems, metrology modules, and controllers. Additional supercritical and/or non-supercritical processing systems can be used. Non-supercritical processing systems can include an etch module, a deposition module, a polishing module, a coating module, a developing module, or a thermal treatment module.

The supercritical processing system 110 can include a Supercritical Processing System (not shown) from Tokyo Electron Limited, Tokyo, Japan, (TEL) that can include one or more supercritical processing chambers. The supercritical processing system 110 can include means for performing material removal processes using supercritical fluid, such as supercritical CO₂. Alternately, other supercritical processes may be performed.

The transfer system 120 can include a transfer system from TEL that can include one or more transfer ports, one or more load lock chambers, and one or more loading/unloading ports (not shown).

The metrology module 130 can include an Optical Digital Profiling (ODP™) system (not shown) from Timbre Technologies Inc. (a TEL company) that provides a patented technique for measuring the profile of a structure in a semiconductor device. Alternately, metrology module 130 may include a Scanning Electron Microscopy (SEM) tool, or a Transmission Electron Microscopy (TEM) tool (not shown).

An ODP™ system can comprise: an ODP™ PROFILER™ Library that includes an application specific database of optical spectra and its corresponding semiconductor profiles, CDs, and film thicknesses; a PROFILER™ Application Server (PAS) that includes a computer server that connects with the optical hardware and computer network, and that handles the data communication, ODP™ library operation, measurement process, results generation, results analysis, and results output; and ODP™ PROFILER™ Software that includes the software installed on PAS to manage measurement recipes, ODP™ PROFILER™ library, ODP™ PROFILER™ data, ODP™ PROFILER™ results search/match, ODP™ PROFILER™ results calculation/analysis, data communication, and the PAS interfaces to various metrology tools and computer network.

ODP™ techniques for creating a metrology model are taught in co-pending U.S. patent application Ser. No. 10/206,491, entitled “Model and Parameter Selection in Optical Metrology” by Voung et al., filed on Jul. 25, 2002, and ODP™ techniques covering integrated metrology applications are taught in U.S. Pat. No. 6,785,638, entitled “Method and System of Dynamic Learning Through a Regression-Based Library Generation Process,” both of which are incorporated by reference herein.

The metrology module 130 can use ODP™ techniques obtain measured data for features on a patterned substrate, and ODP™ techniques can be used to measure the presence and/or thickness of coatings and/or residues within features of a patterned substrate. These techniques are taught in co-pending U.S. patent application Ser. No. 10/357,705, entitled “Model Optimization for Structures with Additional Materials” by Niu et al., filed on Feb. 3, 2003, and ODP™ techniques covering the measurement of additional materials are taught in U.S. Pat. No. 6,608,690, entitled “Optical Profilometry of Additional-Material Deviations in a Periodic Grating,” and in U.S. Pat. No. 6,839,145, entitled “Optical Profilometry of Additional-Material Deviations in a Periodic Grating,” μl of which are incorporated by reference herein.

An exemplary optical metrology system is described in co-pending U.S. patent application Ser. No. 09/727,530 entitled “System and Method for Real-Time Library Generation of Grating Profiles” by Jakatdar et al., filed on Nov. 28, 2000, which is incorporated in its entirety herein by reference.

For example, ODP™ techniques can be used to obtain critical dimension (CD) information, structure profile information, or via profile information. ODP™ techniques can also be used to measure the amount of material in small features and the amount of material on substrate surfaces.

In ODP™, a diffraction grating profile is reconstructed from its optical diffraction responses, at a fixed incident angle and multiple wavelengths. Diffraction data may be acquired from one-dimensionally and two-dimensionally repeating, regularly spaced series of structures. For example, metrology module 130 can include a metrology beam source (not shown) for projecting a metrology beam at the target sample periodic structure on the substrate. The metrology beam can be is directed at an incidence angle from the normal towards the target structure and diffracted at a diffraction angle from the normal. The diffracted beam can be received and a measured metrology signal can be established based on the diffracted beam. For example, the measured metrology signal (grating spectrum data) can be provided to the PAS. The measured metrology signal is compared to a library of simulated metrology signals, which includes library instances of varying structural profiles and simulated metrology signals associated with the structural profiles. In one example, the library instance with the simulated metrology signal best matching the measured metrology signal is selected. The structural profile associated with the matching simulated metrology signal is then assumed to correspond to that of the features of the measured structure.

When comparing a simulated signal from the library to a measured signal, the metrology module 130 or the controller 140 can determine whether a goodness of fit threshold is met. For example, if the goodness of fit threshold is not met, then the identification process continues and another simulated signal is selected; and if the goodness of fit threshold is met, then the identification is stopped, and the results are used to characterize the feature and the resulting feature may be displayed.

In addition, the library can include a combination of a structural profile and a simulated metrology signal associated with the structural profile. For example, a grating profile library may have 500,000 individual profiles. Each grating profile contains feature dimensions, underlying thickness, and calculated spectrum data. For example, a grating feature can comprise a grating top CD, grating bottom CD, a grating thickness, sidewall angle, and underlying thickness. In addition, libraries may include other profile details such as the magnitude of T-topping, footing, rounding, undercut, concave sidewalls, and convex sidewalls as well as the angle of intersection of the sidewall and the underlying thickness.

Metrology data can include substrate, site, structure, composition data, and metrology system settings for the substrate. The metrology module 130 can use spectroscopic ellipsometry, reflectometry, or other optical instruments to measure true device profiles, accurate critical dimensions (CD), and multiple layer film thickness of a substrate. The metrology process can be executed in real time and eliminates the need to break the substrate for performing the analyses. ODP™ can be used with various optical systems for real time profile and CD measurements, and an ODP™ system can be integrated with a supercritical processing system 110 to provide real-time process monitoring and control. A metrology module 130 that uses ODP™ techniques can be used as both a high precision metrology tool to provide actual profile, CD, and film thickness results, and a yield enhancement tool to detect in-line process excursion or process faults.

The supercritical processing system 110, the transfer system 120, the metrology module 130, and/or the system controller 140 can collect, provide, process, store, and display data from various processes. Process data, operational data, and historical data can be stored in a database. Pre-processing and/or post-processing data can be stored in the database. For example, pre-processing data can comprise data associated with an in-coming substrate, and may be fed forward from another processing element. In addition, post-processing data can comprise data associated with an out-going substrate, and may be fed to another processing element. This data can include lot data, batch data, run data, composition data, and substrate history data. The pre-processing data can be used to establish an input state for a substrate, and the post-processing data can be used to establish an output and/or processed state for a substrate.

Data items can be configured as a set of variable parameters sent between the different system elements using Generic Equipment Model/Semiconductor Equipment Communications Standard (GEM/SECS) communications protocol. For example, variable parameters can be passed as part of a measurement recipe and/or a supercritical processing recipe. A recipe may contain more than one sub recipes and each sub recipe can contain variable parameters.

The supercritical processing system 110, the transfer system 120, and the metrology module 130 can include measurement devices and/or sensors (not shown). For example, process data and/or operational data can be obtained from these measurement devices and/or sensors. In addition, data can be obtained from an external device such as a SEM tool, a TEM tool, or a FTIR tool.

Databases can include measurement data, such as CD SEM information. The system controller 140 can use the CD SEM data as reference data and can calculate adjustment factors that can be used to adjust for any offset between the measured data from the metrology module 130 and reference data (CD SEM data). Historical data can include a timestamp, such as a date, and the historical data can be updated when new verified data is available. The database can provide a searchable record of previously performed processes.

Databases can include pre-processing data and/or post-processing data. The system controller 140 can use the difference between pre-processing data associated with an in-coming substrate (input state) and a desired process result (desired state) to predict, select, or calculate a set of process parameters to achieve the desired process result. The controller 140 can select a recipe that changes the state of the substrate from the input state to the desired state. In one embodiment, data such as the input state and/or the desired state data can be obtained from a higher-level system.

In a coupled system as shown in FIG. 1, some of the post-processing data from one system element can be used as pre-processing data for another system element.

For example, an input state for a substrate can be established by making metrology measurements before a supercritical cleaning process, and the input state can be used to provide information about the amount of foreign material in one or more features of the substrate. An output and/or processed state for a substrate can be established by making metrology measurements after a supercritical cleaning process has been performed, and the output and/or processed state can be used to provide information about the amount of foreign material removed during the cleaning process. The system controller 140 can compare the output and/or processed state to the desired state to verify that the substrate has been processed correctly. An error or alarm condition can be established when the substrate has not been processed correctly.

The time constant for the controller 140 can be based on the time between measurements. When measured data is available after a lot is completed, the controller's time constant can be based on the time between lots. When measured data is available after a substrate is completed, the controller's time constant can be based on the time between substrates. When measurement data is provided real-time during processing, the controller's time constant can be based on processing steps, within a substrate. When measured data is available while a substrate is being processed or after a substrate is completed or after the lot is completed, the controller can have multiple time constants that can be based on the time between process steps, between substrates, and/or between lots.

The supercritical processing system 110, the transfer system 120, the metrology module 130, and/or the system controller 140 can generate, process, store, and/or display alarm/fault data from various processes. The system controller 140 can take various actions in response to an alarm/fault condition, depending on the nature of the alarm/fault condition. The actions taken on the alarm/fault can be based on the business rules established for the semiconductor processing system 100. For example, the actions can include: keep the substrate in its current location until it can be determined whether the processing of that substrate can continue without damaging the substrate, move the substrate to a holding position, such as in a transfer chamber, move the substrate to a measurement module, or move the substrate out of the system. In one embodiment, the system controller 140 determines the actions to take. Alternately, the system controller 140 can be instructed to take some specific actions by the MES system 150. In some cases, a recover recipe can be sent in response to an alarm or a fault condition. This can allow the system to make the necessary changes to minimize the number of wafers at risk.

The system controller 140 can include applications for analyzing the collected data, and establishing alarm/error conditions. For example, SPC, PCA, and/or PLS applications may be executed, and may trigger SPC alarms, and other applications may be executed, and may trigger software alarms. An application can create an alarm when a data failure occurs, an execution problem occurs, or a control problem occurs.

System controller 140 can comprise management applications, such as a recipe management application. For example, the recipe management application can be used to view and/or control a recipe stored in the system database. Recipes for the different system components can be synchronized by the controller 140. Recipes can include process recipes, system recipes, and metrology recipes. The process recipes can be used to determine the procedures performed during a supercritical process.

The metrology recipes can be used to determine a substrate sampling plan. Metrology recipes can exist on the metrology module 130, can be coordinated with recipes on the supercritical processing system 110, can contain pattern recognition information, can be used to identify the locations to sample on each substrate, and can be used to determine which PAS recipe to use. PAS recipes can be used to determine which ODP™ library to use, and to define the measurement metrics to report.

In one embodiment, as depicted in FIG. 1, system controller 140 can comprise a processor 142 and a memory 144. Memory 144 can be coupled to processor 142, and can be used for storing information and instructions to be executed by processor 142. Alternately, different controller configurations can be used. In addition, system controller 140 can comprise a port 145 that can be used to couple semiconductor processing system 100 to another system (not shown). Furthermore, controller 120 can comprise input and/or output devices (not shown).

In addition, the supercritical processing system 110, the transfer system 120, and/or the metrology module 130 can comprise memory (not shown) for storing information and instructions to be executed during processing and processors (not shown) for processing information and/or executing instructions. For example, the memory may be used for storing temporary variables or other intermediate information during the execution of instructions by the various processors in the system 100.

One or more of the system elements (110, 120, 130, and 140) can comprise the means for reading data and/or instructions from a computer readable medium. In addition, one or more of the system elements (110, 120, 130, and 140) can comprise the means for writing data and/or instructions to a computer readable medium. Furthermore, one or more of the system elements (110, 120, 130, and 140) can comprise the means for storing data and/or instructions.

Memory devices can include at least one computer readable medium or memory for holding computer-executable instructions programmed according to the teachings of the invention and for containing data structures, tables, records, or other data described herein. System controller 140 can use data from computer readable medium memory to generate and/or execute computer executable instructions. The semiconductor processing system 100 can perform a portion or all of the methods of the invention in response to the system controller 140 executing one or more sequences of one or more computer-executable instructions contained in a memory. Such instructions may be received by the controller 140 from another computer, a computer readable medium, or a network connection.

Stored on any one or on a combination of computer readable media, the present invention includes software for controlling the semiconductor processing system 100, for driving a device or devices for implementing the invention, and for enabling the semiconductor processing system 100 to interact with a human user and/or another system, such as a factory system. Such software may include, but is not limited to, device drivers, operating systems, development tools, and applications software. Such computer readable media further includes the computer program product of the present invention for performing all or a portion (if processing is distributed) of the processing performed in implementing the invention.

In addition, at least one of the supercritical processing system 110, the transfer system 120, the metrology module 130, the system controller 140, and the MES 150 can comprise a GUI component (not shown) and/or a database component (not shown). In alternate embodiments, the GUI component and/or the database component are not required. The user interfaces for the system can be web-enabled, and can provide system status and alarm status displays. For example, a GUI component (not shown) can provide easy to use interfaces that enable users to: view status; create and edit SPC charts; view alarm data; configure data collection applications; configure data analysis applications; examine historical data, and review current data; generate e-mail warnings; run multivariate PCA and/or PLS models; and view diagnostics screens in order to troubleshoot and report problems with the semiconductor processing system 100.

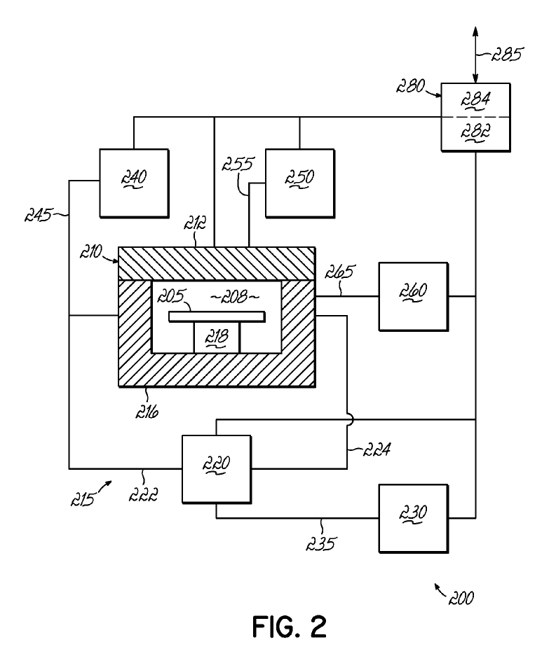

FIG. 2 shows an exemplary block diagram of a processing system in accordance with embodiments of the invention. In the illustrated embodiment, a supercritical processing system 200 is shown that comprises a supercritical process module 210 for processing a substrate 205 in a processing chamber 208, a recirculation system 220, a process chemistry supply system 230, a high-pressure fluid supply system 240, a pressure control system 250, an exhaust system 260, and a controller 280. In an alternate embodiment, supercritical processing system 200 may be configured differently. The supercritical processing system 200 can operate at pressures that can range from 1000 psi to 10,000 psi. In addition, the supercritical processing system 200 can operate at temperatures that can range from 40 to 300 degrees Celsius.

The details concerning one example of a processing chamber are disclosed in co-owned and co-pending U.S. patent application Ser. No. 09/912,844, entitled “High Pressure Processing Chamber for Semiconductor Substrate,” filed Jul. 24, 2001; Ser. No. 09/970,309, entitled “High Pressure Processing Chamber for Multiple Semiconductor Substrates,” filed Oct. 3, 2001; Ser. No. 10/121,791, entitled “High Pressure Processing Chamber for Semiconductor Substrate Including Flow Enhancing Features,” filed Apr. 10, 2002; and Ser. No. 10/364,284, entitled “High-Pressure Processing Chamber for a Semiconductor Wafer,” filed Feb. 10, 2003, the contents of which are incorporated herein by reference.

The controller 280 can be coupled to the process module 210, the recirculation system 220, the process chemistry supply system 230, the high-pressure fluid supply system 240, the pressure control system 250, and the exhaust system 260. Alternately, controller 280 can be coupled to one or more additional controllers/computers (not shown), and controller 280 can obtain setup, configuration, and/or recipe information from an additional controller/computer.

In FIG. 2, singular processing elements (210, 220, 230, 240, 250, 260, and 280) are shown, but this is not required for the invention. The supercritical processing system 200 can comprise any number of processing elements having any number of controllers associated with them in addition to independent processing elements.

The controller 280 can be used to configure any number of processing elements (210, 220, 230, 240, 250, and 260), and the controller 280 can collect, provide, process, store, and display data from processing elements. The controller 280 can comprise a number of applications for controlling one or more of the processing elements. For example, controller 280 can include a graphic user interface (GUI) component (not shown) that can provide easy-to-use interfaces that enable a user to monitor and/or control one or more processing elements.

The process module 210 can include a processing chamber 208 enclosed by an upper assembly 212 and a lower assembly 216, and the upper assembly 212 can be coupled to the lower assembly 216. In an alternate embodiment, a frame and/or injection ring (not shown) may be included and may be coupled to the upper assembly 212 and the lower assembly 216. The upper assembly 212 can comprise a heater (not shown) for heating the processing chamber 208, the substrate 205, or the processing fluid, or a combination of two or more thereof. Alternately, a heater is not required in the upper assembly 212. In another embodiment, the lower assembly 216 can comprise a heater (not shown) for heating the processing chamber 208, the substrate 205, or the processing fluid, or a combination of two or more thereof. The process module 210 can include means for flowing a processing fluid through the processing chamber 208. In one example, a circular flow pattern can be established, and in another example, a substantially linear flow pattern can be established. Alternately, the means for flowing can be configured differently.

In one embodiment, the process module 210 can include a holder or chuck 218 for supporting and holding the substrate 205 while processing the substrate 205. The lower assembly 216 can comprise one or more lifters (not shown) for moving the chuck 218 and/or the substrate 205. Alternately, a lifter is not required. The holder or chuck 218 can also be configured to heat or cool the substrate 205 before, during, and/or after processing the substrate 205. Alternately, the process module 210 can include a platen for supporting and holding the substrate 205 while processing the substrate 205.

A transfer system (not shown) can be used to move a substrate 205 into and out of the processing chamber 208 through a slot (not shown). In one example, the slot can be opened and closed by moving the chuck 218, and in another example, the slot can be controlled using a gate valve.

The substrate 205 can include semiconductor material, metallic material, dielectric material, ceramic material, or polymer material, or a combination of two or more thereof. The semiconductor material can include Si, Ge, Si/Ge, or GaAs. The metallic material can include Cu, Al, Ni, Pb, Ti, Ta, or W, or combinations of two or more thereof. The dielectric material can include Si, O, N, or C, or combinations of two or more thereof. The ceramic material can include Al, N, Si, C, or O, or combinations of two or more thereof.

The recirculation system 220 can be coupled to the process module 210 using one or more inlet lines 222 and one or more outlet lines 224 to form a recirculation loop 215. The recirculation system 220 can comprise one or more valves (not shown) for regulating the flow of a supercritical processing solution through the recirculation system 220 and through the process module 210. The recirculation system 220 can comprise any number of back-flow valves, filters, pumps, and/or heaters (not shown) for maintaining a supercritical processing solution and flowing the supercritical processing solution through the recirculation system 220 and through the processing chamber 208 in the process module 210. After introducing a fluid to the processing chamber 208, the fluid can be recirculated through the processing chamber 208 via recirculation loop 215, such as continuously for a desired period of time or discontinuously a desired number of times.

Supercritical processing system 200 can comprise a process chemistry supply system 230. In the illustrated embodiment, the process chemistry supply system 230 is coupled to the recirculation system 220 using one or more lines 235, but this is not required for the invention. In alternate embodiments, the process chemical supply system 230 can be configured differently and can be coupled to different elements in the processing system 200. For example, the process chemistry supply system 230 can be coupled to the process module 210.

The process chemistry is introduced by the process chemistry supply system 230 into the fluid introduced by the high-pressure fluid supply system 240 at ratios that vary with the substrate properties, the chemistry being used, and the process being performed in the processing chamber 208. The ratio can vary from approximately 0.001 to approximately 15 percent by volume. For example, when the recirculation loop 215 comprises a volume of about one liter, the process chemistry volumes can range from approximately ten microliters to approximately one hundred fifty milliliters. In alternate embodiments, the volume and/or the ratio may be higher or lower.

The process chemistry supply system 230 can be configured to introduce one or more of the following process compositions, but not limited to: cleaning compositions for removing contaminants, residues, hardened residues, photoresist, hardened photoresist, post-etch residue, post-ash residue, post chemical-mechanical polishing (CMP) residue, post-polishing residue, or post-implant residue, or any combination thereof; cleaning compositions for removing particulate; drying compositions for drying thin films, porous thin films, porous low dielectric constant materials, or air-gap dielectrics, or any combination thereof; film-forming compositions for preparing dielectric thin films, metal thin films, or any combination thereof; healing compositions for restoring the dielectric constant of low-k films; sealing compositions for sealing porous films; or any combination thereof. Additionally, the process chemistry supply system 230 can be configured to introduce solvents, co-solvents, surfactants, etchants, acids, bases, chelators, oxidizers, film-forming precursors, or reducing agents, or any combination thereof.

The process chemistry supply system 230 can be configured to introduce N-methyl pyrrolidone (NMP), diglycol amine, hydroxylamine, di-isopropyl amine, tri-isopropyl amine, tertiary amines, catechol, ammonium fluoride, ammonium bifluoride, methylacetoacetamide, ozone, propylene glycol monoethyl ether acetate, acetylacetone, dibasic esters, ethyl lactate, CHF₃, BF₃, HF, other fluorine containing chemicals, or any mixture thereof. Other chemicals such as organic solvents may be utilized independently or in conjunction with the above chemicals to remove organic materials. The organic solvents may include, for example, an alcohol, ether, and/or glycol, such as acetone, diacetone alcohol, dimethyl sulfoxide (DMSO), ethylene glycol, methanol, ethanol, propanol, or isopropanol (IPA). For further details, see U.S. Pat. No. 6,306,564B1 entitled “Removal of Resist or Residue from Semiconductors Using Supercritical Carbon Dioxide” and U.S. Pat. No. 6,509,141B2 entitled “Removal of Photoresist and Photoresist Residue from Semiconductors Using Supercritical Carbon Dioxide Process,” both incorporated by reference herein.

The process chemistry supply system 230 can comprise post-treating chemistry assemblies (not shown) for introducing post-treating chemistry for curing, cleaning, healing (or restoring the dielectric constant of low-k materials), or sealing, or any combination, low dielectric constant films (porous or non-porous). The chemistry can include hexamethyldisilazane (HMDS), chlorotrimethylsilane (TMCS), trichloromethylsilane (TCMS), dimethylsilyldiethylamine (DMSDEA), tetramethyldisilazane (TMDS), trimethylsilyldimethylamine (TMSDMA), dimethylsilyldimethylamine (DMSDMA), trimethylsilyldiethylamine (TMSDEA), bistrimethylsilyl urea (BTSU), bis(dimethylamino)methyl silane (B[DMA]MS), bis (dimethylamino)dimethyl silane (B[DMA]DS), HMCTS, dimethylaminopentamethyldisilane (DMAPMDS), dimethylaminodimethyldisilane (DMADMDS), disila-aza-cyclopentane (TDACP), disila-oza-cyclopentane (TDOCP), methyltrimethoxysilane (MTMOS), vinyltrimethoxysilane (VTMOS), or trimethylsilylimidazole (TMSI). Additionally, the chemistry may include N-tert-butyl-1,1-dimethyl-1-(2,3,4,5-tetramethyl-2,4-cyclopentadiene-1-yl)silanamine, 1,3-diphenyl-1,1,3,3-tetramethyldisilazane, or tert-butylchlorodiphenylsilane. For further details, see U.S. patent application Ser. No. 10/682,196, filed Oct. 10, 2003, entitled “Method and System for Treating a Dielectric Film,” and U.S. patent application Ser. No. 10/379,984, filed Mar. 4, 2003, entitled “Method of Passivating Low Dielectric Materials in Wafer Processing,” both of which are incorporated by reference herein.

The process chemistry supply system 230 can comprise a rinsing chemistry assembly (not shown) for providing rinsing chemistry for generating supercritical rinsing solutions within the processing chamber 208. The rinsing chemistry can include one or more organic solvents including, but not limited to, alcohols and ketones. In one embodiment, the rinsing chemistry can comprise an alcohol and a carrier solvent. The process chemistry supply system 230 can comprise a drying chemistry assembly (not shown) for providing drying chemistry for generating supercritical drying solutions within the processing chamber 208.

In addition, the process chemistry can include chelating agents, complexing agents, oxidants, organic acids, and inorganic acids that can be introduced into supercritical carbon dioxide with one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such as methanol, ethanol, isopropanol and 1-propanol).

Furthermore, the process chemistry can include solvents, co-solvents, surfactants, and/or other ingredients. Examples of solvents, co-solvents, and surfactants are disclosed in co-owned U.S. Pat. No. 6,500,605, entitled “Removal of Photoresist and Residue from Substrate Using Supercritical Carbon Dioxide Process,” issued Dec. 31, 2002, and U.S. Pat. No. 6,277,753, entitled “Removal of CMP Residue from Semiconductors Using Supercritical Carbon Dioxide Process,” issued Aug. 21, 2001, both of which are incorporated by reference herein.

Moreover, the process chemistry supply system 230 can be configured to introduce a peroxide during, for instance, cleaning processes. The peroxide can be introduced with any one of the above process chemistries, or any mixture thereof. The peroxide can include organic peroxides, or inorganic peroxides, or a combination thereof. For example, organic peroxides can include 2-butanone peroxide; 2,4-pentanedione peroxide; peracetic acid; t-butyl hydroperoxide; benzoyl peroxide; or m-chloroperbenzoic acid (mCPBA). Other peroxides can include hydrogen peroxide. Alternatively, the peroxide can include a diacyl peroxide, such as: decanoyl peroxide; lauroyl peroxide; succinic acid peroxide; or benzoyl peroxide; or any combination thereof. Alternatively, the peroxide can include a dialkyl peroxide, such as: dicumyl peroxide; 2,5-di(t-butylperoxy)-2,5-dimethylhexane; t-butyl cumyl peroxide; α,α-bis(t-butylperoxy)diisopropylbenzene mixture of isomers; di(t-amyl) peroxide; di(t-butyl) peroxide; or 2,5-di(t-butylperoxy)-2,5-dimethyl-3-hexyne; or any combination thereof. Alternatively, the peroxide can include a diperoxyketal, such as: 1,1-di(t-butylperoxy)-3,3,5-trimethylcyclohexane; 1,1-di(t-butylperoxy)cyclohexane; 1,1-di(t-amylperoxy)cyclohexane; n-butyl 4,4-di(t-butylperoxy)valerate; ethyl 3,3-di-(t-amylperoxy)butanoate; t-butyl peroxy-2-ethylhexanoate; or ethyl 3,3-di(t-butylperoxy)butyrate; or any combination thereof. Alternatively, the peroxide can include a hydroperoxide, such as: cumene hydroperoxide; or t-butyl hydroperoxide; or any combination thereof. Alternatively, the peroxide can include a ketone peroxide, such as: methyl ethyl ketone peroxide; or 2,4-pentanedione peroxide; or any combination thereof. Alternatively, the peroxide can include a peroxydicarbonate, such as: di(n-propyl)peroxydicarbonate; di(sec-butyl)peroxydicarbonate; or di(2-ethylhexyl)peroxydicarbonate; or any combination thereof. Alternatively, the peroxide can include a peroxyester, such as: 3-hydroxyl-1,1-dimethylbutyl peroxyneodecanoate; α-cumyl peroxyneodecanoate; t-amyl peroxyneodecanoate; t-butyl peroxyneodecanoate; t-butyl peroxypivalate; 2,5-di(2-ethylhexanoylperoxy)-2,5-dimethylhexane; t-amyl peroxy-2-ethylhexanoate; t-butyl peroxy-2-ethylhexanoate; t-amyl peroxyacetate; t-butyl peroxyacetate; t-butyl peroxybenzoate; OO-(t-amyl) O-(2-ethylhexyl)monoperoxycarbonate; OO-(t-butyl) O-isopropyl monoperoxycarbonate; OO-(t-butyl) O-(2-ethylhexyl)monoperoxycarbonate; polyether poly-t-butylperoxy carbonate; or t-butyl peroxy-3,5,5-trimethylhexanoate; or any combination thereof. Alternatively, the peroxide can include any combination of peroxides listed above.

In other embodiments, the process chemistry supply system 230 can be configured to introduce fluorosilicic acid. Alternatively, the process chemistry supply system 230 is configured to introduce fluorosilicic acid with a solvent, a co-solvent, a surfactant, another acid, a base, a peroxide, or an etchant. Alternatively, the fluorosilicic acid can be introduced in combination with any of the chemicals presented above. For example, fluorosilicic acid can be introduced with N,N-dimethylacetamide (DMAc), gamma-butyrolactone (BLO), dimethyl sulfoxide (DMSO), ethylene carbonate (EC), butylene carbonate (BC), propylene carbonate (PC), N-methylpyrrolidone (NMP), dimethylpiperidone, propylene carbonate, or an alcohol (such a methanol (MeOH), 1-propanol, isopropyl alcohol (IPA), or ethanol).

In one embodiment, the process chemistry supply system 230 can be configured to introduce a functionalizing agent. For example, the functionalizing agent can include an acyl halide (e.g., benzyl chloride), an alkyl halide (e.g., chloromethane, chloroethane, 2-chloroisopropane, etc.), and/or an acyl alcohol (e.g., benzyl alcohol). The functionalizing agent can be introduced with a solvent or a cosolvent. Alternatively, the functionalizing agent can be introduced in combination with any of the chemicals presented above.

The supercritical processing system 200 can comprise a high-pressure fluid supply system 240. As shown in FIG. 2, the high-pressure fluid supply system 240 can be coupled to the recirculation system 220 using one or more lines 245, but this is not required. The inlet line 245 can be equipped with one or more back-flow valves, and/or heaters (not shown) for controlling the fluid flow from the high-pressure fluid supply system 240. In alternate embodiments, high-pressure fluid supply system 240 can be configured differently and coupled differently. For example, the high-pressure fluid supply system 240 can be coupled to the process module 210.

The high-pressure fluid supply system 240 can comprise a carbon dioxide source (not shown) and a plurality of flow control elements (not shown) for generating a supercritical fluid. For example, the carbon dioxide source can include a CO₂ feed system, and the flow control elements can include supply lines, valves, filters, pumps, and heaters. The high-pressure fluid supply system 240 can comprise an inlet valve (not shown) that is configured to open and close to allow or prevent the stream of supercritical carbon dioxide from flowing into the processing chamber 208. For example, controller 280 can be used to determine fluid parameters such as pressure, temperature, process time, and flow rate.

The supercritical processing system 200 can also comprise a pressure control system 250. As shown in FIG. 2, the pressure control system 250 can be coupled to the process module 210 using one or more lines 255, but this is not required. Line 255 can be equipped with one or more back-flow valves, and/or heaters (not shown) for controlling the fluid flow to pressure control system 250. In alternate embodiments, pressure control system 250 can be configured differently and coupled differently. The pressure control system 250 can include one or more pressure valves (not shown) for exhausting the processing chamber 208 and/or for regulating the pressure within the processing chamber 208. Alternately, the pressure control system 250 can also include one or more pumps (not shown). For example, one pump may be used to increase the pressure within the processing chamber 208, and another pump may be used to evacuate the processing chamber 208. In another embodiment, the pressure control system 250 can comprise means for sealing the processing chamber 208. In addition, the pressure control system 250 can comprise means for raising and lowering the substrate 205 and/or the chuck 218.

Furthermore, the supercritical processing system 200 can comprise an exhaust control system 260. As shown in FIG. 2, the exhaust control system 260 can be coupled to the process module 210 using one or more lines 265, but this is not required. Line 265 can be equipped with one or more back-flow valves, and/or heaters (not shown) for controlling the fluid flow to the exhaust control system 260. In alternate embodiments, exhaust control system 260 can be configured differently and coupled differently. The exhaust control system 260 can include an exhaust gas collection vessel (not shown) and can be used to remove contaminants from the processing fluid. Alternately, the exhaust control system 260 can be used to recycle the processing fluid.

In one embodiment, controller 280 can comprise a processor 282 and a memory 284. Memory 284 can be coupled to processor 282, and can be used for storing information and instructions to be executed by processor 282. Alternately, different controller configurations can be used. In addition, controller 280 can comprise a port 285 that can be used to couple supercritical processing system 200 to another system (not shown). Furthermore, controller 280 can comprise input and/or output devices (not shown).

In addition, one or more of the processing elements (210, 220, 230, 240, 250, 260, and 280) may include memory (not shown) for storing information and instructions to be executed during processing and processors for processing information and/or executing instructions. For example, the memory may be used for storing temporary variables or other intermediate information during the execution of instructions by the various processors in the system. One or more of the processing elements can comprise the means for reading data and/or instructions from a computer readable medium. In addition, one or more of the processing elements can comprise the means for writing data and/or instructions to a computer readable medium.

Memory devices can include at least one computer readable medium or memory for holding computer-executable instructions programmed according to the teachings of the invention and for containing data structures, tables, records, or other data described herein. Controller 280 can use data from computer readable medium memory to generate and/or execute computer executable instructions. The supercritical processing system 200 can perform a portion or all of the processing steps in a supercritical processing recipe in response to the controller 280 executing one or more sequences of one or more computer-executable instructions contained in a memory. Such instructions may be received by the controller from another computer, a computer readable medium, or a network connection.

Stored on any one or on a combination of computer readable media, the present invention includes software for controlling the processing system 200, for driving a device or devices for implementing the invention, and for enabling the supercritical processing system 200 to interact with a human user and/or another system, such as a factory system. Such software may include, but is not limited to, device drivers, operating systems, development tools, and applications software. Such computer readable media further includes the computer program product of the present invention for performing all or a portion (if processing is distributed) of the processing performed in implementing the invention.

The term “computer readable medium” as used herein refers to any medium that participates in providing instructions to a processor for execution and/or that participates in storing information before, during, and/or after executing an instruction. A computer readable medium may take many forms, including but not limited to, non-volatile media, volatile media, and transmission media. The term “computer-executable instruction” as used herein refers to any computer code and/or software that can be executed by a processor, that provides instructions to a processor for execution and/or that participates in storing information before, during, and/or after executing an instruction.

Controller 280, processor 282, memory 284 and other processors and memory in other system elements as described thus far can, unless indicated otherwise below, be constituted by components known in the art or constructed according to principles known in the art. The computer readable medium and the computer executable instructions can also, unless indicated otherwise below, be constituted by components known in the art or constructed according to principles known in the art.

Controller 280 can use port 285 to obtain computer code and/or software from another system (not shown), such as a factory system. The computer code and/or software can be used to establish a control hierarchy. For example, the supercritical processing system 200 can operate independently, or can be controlled to some degree by a higher-level system (not shown).

The controller 280 can use business rules to determine when to change, pause, and/or stop a process in one or more of the processing elements in the supercritical processing system 200. The controller 280 can use the data and operational rules to determine when to change a process and how to change the process, and rules can be used to specify the action taken for normal processing and the actions taken on exceptional conditions. Operational rules can be used to determine which processes are monitored and which data is used. For example, rules can be used to determine how to manage the data when a process is changed, paused, and/or stopped. In general, rules allow system and/or tool operation to change based on the dynamic state of the system.

Controller 280 can receive, send, use, and/or generate pre-processing data and/or historical data. Data associated with an incoming substrate can be used to establish an input state for a substrate and/or a current state for a process module. Pre-processing data and/or historical data can include process parameters. Data associated with a processed substrate can be used to establish an output and/or processed state for a substrate.

The controller 280 can use pre-processing data to predict, select, or calculate a recipe (process parameters) to use to process the substrate using the supercritical processing system 200. The pre-processing data can include data describing the substrate to be processed and can include metrology data. For example, the pre-processing data can include information concerning the substrate's materials, the number of layers, the materials used for the different layers, the thickness of materials in the layers, the size of vias and trenches, the amount/type of process residue, the amount/type of oxidized and/or partially oxidized process residue, and a desired process result. The pre-processing data can be used to determine a supercritical process recipe and/or supercritical process model. A supercritical process model can provide the relationship between one or more supercritical process recipe parameters and one or more supercritical process results. A supercritical process recipe can include a multi-step process involving a set of supercritical and/or non-supercritical processing chambers. Post-processing data can be obtained at some point after the substrate has been processed by the supercritical processing system 200. For example, post-processing data for a supercritical process can be obtained from an internal and/or external metrology module (not shown) and can be available after a time delay that can vary from minutes to days.

The controller 280 can compute a predicted state for the substrate based on the pre-processing data, the supercritical processing system characteristics, and/or a process model. For example, a model for a supercritical residue removal process can be used along with a material type and thickness to compute a predicted process residue removal time. In addition, a removal rate model can be used along with the type of process residue and/or residue amount to compute a processing time for a removal process.

In one embodiment, the substrate can comprise at least one of a semiconductor material, a metallic material, a polysilicon material, low-k material, and process-related material. For example, the process-related material can include photoresist and/or photoresist residue, oxidized and/or partially oxidized residues. Some supercritical process recipes can include procedures for oxidizing residues and removing oxidized and/or partially oxidized residues from patterned or un-patterned low-k material. Additional supercritical process recipes can include non-oxidizing procedures for cleaning, rinsing, and/or treating low-k material. Those skilled in the art will recognize that low-k material can include low-k and ultra-low-k material.

It will be appreciated that the controller 280 can perform other functions in addition to those discussed here. The controller 280 can monitor the pressure, temperature, flow, or other variables associated with the supercritical processing system 200 and take actions based on these values. For example, the controller 280 can process data associated with the supercritical processing system 200, display the data and/or results on a GUI screen, determine an alarm/fault condition, determine a response to an alarm/fault condition, and send/display a message.

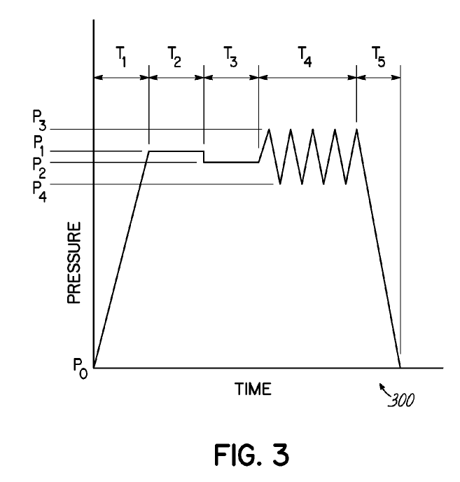

FIG. 3 illustrates an exemplary graph of pressure versus time for a supercritical process in accordance with embodiments of the invention. In the illustrated embodiment, a graph 300 of pressure versus time is shown, and the graph 300 can be used to represent a supercritical cleaning process, a supercritical rinsing process, or a supercritical treatment process, or a combination thereof. Alternately, different pressures, different timing, and different sequences may be used for different processes. In addition, although a single time sequence is illustrated in FIG. 3, this is not required for the invention. Alternately, multi-sequence processes may be used.

In one embodiment, each substrate has been measured in a metrology module before the supercritical process shown in FIG. 3 is performed. Alternately, one or more substrates can bypass the metrology module. In addition, the data from the metrology module can be used to determine the type of supercritical processing performed on each substrate. For example, a supercritical processing recipe can be determined for each substrate.

Referring to FIGS. 1-3, prior to an initial time T₀, the substrate to be processed can be placed within the processing chamber 208 and the processing chamber can be sealed. For example, during cleaning, rinsing, and/or curing processes, a substrate can have post-etch and/or post-ash residue thereon. The substrate 205, the processing chamber 208, and the other elements in the recirculation loop 215 can be heated to an operational temperature. For example, the operational temperature can range from 40 to 300 degrees Celsius.

During time T₁, the processing chamber 208 and the other elements in the recirculation loop 215 can be pressurized. During at least one portion of the time T₁, the high-pressure fluid supply system 240 can be coupled into the flow path and can be used to provide temperature controlled carbon dioxide into the processing chamber and/or other elements in the recirculation loop 215. For example, the temperature variation of the temperature-controlled carbon dioxide can be controlled to be less than approximately ten degrees Celsius during the pressurization process.

In one embodiment, sensors (not shown) located at different points in the recirculation loop 215 can operate during the time T₁ and can provide process data that can be used to verify that the correct supercritical processing recipe is being performed. Alternately, the sensor assembly may not be operated during the time T₁. During time T₁, a pump (not shown) in the recirculation system 220 can be started and can be used to circulate the temperature controlled fluid through the processing chamber 208, and the other elements in the recirculation loop 215.

In one embodiment, when the pressure in the processing chamber 208 exceeds a critical pressure (1,070 psi), process chemistry can be injected into the recirculation loop 215 using the process chemistry supply system 230. In one embodiment, the high-pressure fluid supply system 240 can be switched off before the process chemistry is injected. Alternately, the high-pressure fluid supply system 240 can be switched on while the process chemistry is injected.

In other embodiments, process chemistry may be injected into the processing chamber 208 before the pressure exceeds the critical pressure using the process chemistry supply system 230. For example, the injection(s) of the process chemistries can begin upon reaching about 1100-1200 psi. In other embodiments, process chemistry is not injected during the T₁ period.

Process data can be obtained before, during, and/or after the process chemistry is injected. For example, temperature data can be used to control the injection process. Process chemistry can be injected in a linear fashion, and the injection time can be based on a recirculation time. For example, the recirculation time can be determined based on the length of the recirculation path and the flow rate. In other embodiments, process chemistry may be injected in a non-linear fashion. For example, process chemistry can be injected at one or more times during the process.

The process chemistry can include a cleaning agent, a rinsing agent, or a curing agent, or a combination thereof that is injected into the supercritical fluid. One or more injections of process chemistries can be performed over the duration of time T₁ to generate a supercritical processing solution with the desired concentrations of chemicals. The process chemistry, in accordance with the embodiments of the invention, can also include one more or more carrier solvents.

Still referring to both FIGS. 2-3, during a second time T₂, the supercritical processing solution can be re-circulated over the substrate 205 and through the processing chamber 208, and the other elements in the recirculation loop 215. Process data can be collected while the supercritical processing solution is being re-circulated. The process data can be used to control the chemical composition while the supercritical processing solution is being re-circulated.

The processing chamber 208 can operate at a pressure P₁ above 2,500 psi during the second time T₂. For example, the pressure can range from approximately 2,500 psi to approximately 3,100 psi, but can be any value so long as the operating pressure is sufficient to maintain supercritical conditions. The supercritical processing solution can be circulated over the substrate 205 and through the recirculation loop 215. The supercritical conditions within the processing chamber 208 and the other elements in the recirculation loop 215 are maintained during the second time T₂, and the supercritical processing solution continues to be circulated over the substrate 205 and through the processing chamber 208 and the other elements in the recirculation loop 215. The recirculation system 220 can be used to regulate the flow of the supercritical processing solution through the processing chamber 208 and the other elements in the recirculation loop 215.

Still referring to FIGS. 2-3, during a third time T₃, one or more push-through processes can be performed. The high-pressure fluid supply system 240 can comprise means for providing a first volume of temperature-controlled fluid during a push-through process, and the first volume can be larger than the volume of the recirculation loop 215. Alternately, the first volume can be less than or approximately equal to the volume of the recirculation loop 215. In addition, the temperature differential within the first volume of temperature-controlled fluid during the push-through process can be controlled to be less than approximately ten degrees Celsius.

In one embodiment, process data can be collected during a push-through process, and can be used to control the process parameters during a push-through process. For example, during the third time T₃, one or more volumes of temperature controlled supercritical carbon dioxide can be fed into the recirculation loop 215, and the supercritical processing solution along with process residue suspended or dissolved therein can be displaced from the processing chamber 208 and the other elements in the recirculation loop 215 through the exhaust system 260. The process data can be examined to determine the amount of process residue in the processing solution during a push-through. Providing temperature-controlled fluid during the push-through process prevents process residue suspended or dissolved within the fluid being displaced from the processing chamber 208 and the other elements in the recirculation loop 215 from dropping out and/or adhering to the processing chamber 208 and the other elements in the recirculation loop 215. In addition, during the third time T₃, the temperature of the fluid supplied by the high-pressure fluid supply system 240 can vary over a wider temperature range than the range used during the second time T₂.

In the illustrated embodiment shown in FIG. 3, a single second time T₂ is followed by a single third time T₃, but this is not required. In alternate embodiments, other time sequences may be used to process a substrate. In addition, during the second time T₂, the pressure P₁ can be higher than the pressure P₂ during the third time T₃. Alternately, P₁ and P₂ may have different values.

After the push-through process is complete, a pressure cycling process can be performed. Alternately, one or more pressure cycles can occur during the push-through process. In other embodiments, a pressure cycling process is not required. During a fourth time T₄, the processing chamber 208 can be cycled through a plurality of decompression and compression cycles. The pressure can be cycled between a pressure P₃ and a pressure P₄ one or more times. In alternate embodiments, the pressure P₃ and the pressure P₄ can vary. In one embodiment, the pressure can be lowered by venting through the exhaust system 260. For example, this can be accomplished by lowering the pressure to below approximately 2,500 psi and raising the pressure to above approximately 2,500 psi. The pressure can be increased by providing additional high-pressure fluid.

A first volume of temperature-controlled fluid can be provided during a compression cycle, and the first volume can be larger than the volume of the recirculation loop 215. Alternately, the first volume can be less than or approximately equal to the volume of the recirculation loop 215. In addition, the temperature differential within the first volume of temperature-controlled fluid during the compression cycle can be controlled to be less than approximately ten degrees Celsius. In addition, a second volume of temperature-controlled fluid can be provided during a decompression cycle, and the second volume can be larger than the volume of the recirculation loop 215. Alternately, the second volume can be less than or approximately equal to the volume of the recirculation loop 215. In addition, the temperature differential within the second volume of temperature-controlled fluid during the decompression cycle can be controlled to be less than approximately ten degrees Celsius. Alternately, the temperature variation of the temperature-controlled fluid can be controlled to be less than approximately five degrees Celsius during a decompression cycle.

In one embodiment, process data can be collected during a decompression cycle. Alternately, process data may not be collected during a decompression cycle. The process data can be examined to determine the amount of process residue in the processing solution before, during, and/or after a decompression cycle.

Providing temperature-controlled fluid during the pressure cycling process prevents process residue suspended or dissolved within the fluid being displaced from the processing chamber 208 and the other elements in the recirculation loop 215 from dropping out and/or adhering to the processing chamber 208 and the other elements in the recirculation loop 215. In addition, during the fourth time T₄, the temperature of the fluid supplied by the high-pressure fluid supply system 240 can vary over a wider temperature range than the range used during the second time T₂.

In the illustrated embodiment shown in FIG. 3, a single third time T₃ is followed by a single fourth time T₄, but this is not required. In alternate embodiments, other time sequences may be used to process a substrate.

During a fifth time T₅, the processing chamber 208 can be returned to lower pressure. For example, after the pressure cycling process is completed, then the processing chamber 208 can be vented or exhausted to a pressure compatible with a transfer system.

In one embodiment, process data can be collected during a venting process. Alternately, process data may not be collected during a venting process. The process data can be examined to determine the amount of process residue in the processing solution before, during, and/or after a venting process. The process recipe can be used to establish the correct volume of temperature-controlled fluid during a venting process. For example, during the fifth time T₅, one or more volumes of temperature controlled supercritical carbon dioxide can be fed into the processing chamber 208 and the other elements in the recirculation loop 215, and the remaining processing solution along with process residue suspended or dissolved therein can be displaced from the processing chamber 208 and the other elements in the recirculation loop 215 through the exhaust system 260.

In the illustrated embodiment shown in FIG. 3, a single fourth time T₄ is followed by a single fifth time T₅, but this is not required. In alternate embodiments, other time sequences may be used to process a substrate.

After substrate processing in the processing chamber 208, the chamber pressure can be made substantially equal to the pressure inside of a transfer chamber (not shown) coupled to the processing chamber 208. In one embodiment, the substrate 205 can be moved from the processing chamber 208 into the transfer chamber, and moved to a metrology module (not shown) where post-processing metrology data can be obtained or to another processing system (not shown) where additional processing can be performed.

In the illustrated embodiment shown in FIG. 3, the pressure returns to an initial pressure P₀, but this is not required for the invention. In alternate embodiments, the pressure does not have to return to P₀, and the process sequence can continue with additional procedures such as those shown in T₁, T₂, T₃, T₄, or T₅.

In another embodiment, the controller 280 can use historical data and/or process models to compute an expected value for one or more process parameters at various times during the process. The controller 280 can compare an expected value to a measured value to determine when to change, pause, and/or stop a process.

The graph 300 is provided for exemplary purposes only. It will be understood by those skilled in the art that a supercritical processing recipe can have any number of different time/pressures or temperature profiles. Further, a supercritical processing recipe can comprise any number of cleaning, rinsing, and/or treatment process sequences. In addition, concentrations of various chemicals and species within a supercritical processing solution are dependent upon the supercritical processing recipe and can be executed and can be changed at any time within a supercritical process.

After a supercritical process has been performed, a substrate can be measured using an optical measuring device, such as an ODP™ tool, a SEM tool, and/or a TEM tool. For example, the substrate can be transferred to a metrology module and ODP™ techniques can be used measure the substrate 205. When a supercritical cleaning process is performed, the desired process result can be clean features, and the metrology data can be used to ensure that the amount of residue and/or contaminant in a feature or on the surface of a substrate is substantially zero.

In other embodiments, the desired process result can be a process result that is measurable using Fourier Transform Infrared Spectroscopy (FTIR) which is an analytical technique used to identify materials. The FTIR technique measures the absorption of various infrared light wavelengths by the material of interest. These infrared absorption bands identify specific molecular components and structures. The absorption bands in the region between 1500-400 wave numbers are generally due to intra-molecular phenomena, and are highly specific for each material. The specificity of these bands allows computerized data searches to be performed against reference libraries to identify a material and/or identify the presence of a material.

In addition, additional processes can be performed after a residue removal process is performed. For example, a pore sealing, a k-value restoration, a rinsing process, a cleaning process, or a drying process, or a combination thereof can be performed. These additional processes may require other processing chemistry to be circulated within the processing chamber. For example, the removal chemistry can include alcohol and water, and the rinsing chemistry does not include water. Alternately, drying steps may be included.

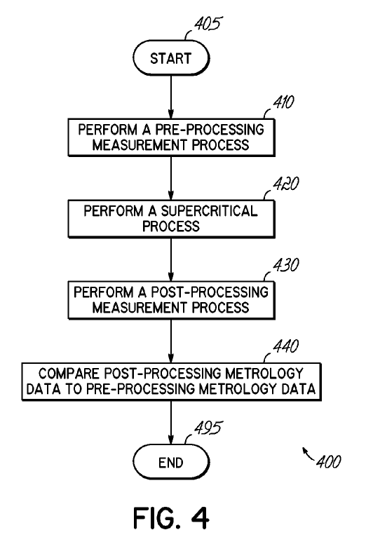

FIG. 4 illustrates a flow chart of a method of performing a supercritical residue removal process on a substrate in accordance with embodiments of the present invention. Procedure 400 can start in 405.

In 410, a pre-processing measurement process can be performed. During a processing measurement process, a substrate can be measured using optical measurement systems. For example, a metrology module can use ODP™ techniques to obtain measured data for features on a patterned substrate, and ODP™ techniques can be used to measure the presence and/or thickness of coatings and/or residues within features of a patterned substrate.

During a pre-processing measurement process, a substrate can be positioned on a holder in a chamber in a metrology module. In one embodiment, the substrate can be aligned before being positioned in the measurement module. Alternately, pre-alignment of the substrate is not required. For example, a substrate can be aligned in the metrology module.

During a pre-processing measurement process, the controller and/or the metrology module can select the metrology recipe to use, the PAS recipe to use and the ODP™ recipe to use.

During a pre-processing measurement process, the thickness of the material to be removed during a cleaning operation can be determined. This thickness information can be used to determine the recipe parameters to use during the cleaning operation.

Before, during, and/or after a pre-processing measurement process, the controller can receive data, process data, store data, and/or send data. The data can include input data, output data, process data, historical data, tool/chamber data, and alarm data. The data can also include pre-process metrology data, post-process metrology data, site measurement data, and/or substrate data. In addition, the data can include rules from a higher-level system that the metrology module can use to verify and/or process the data. The metrology module can generate alarm data when data is not received and/or not verified. For example, the metrology module may request a data sender to resend the data.

During the pre-processing measurement process, pre-process metrology data can be created by the metrology module, and the pre-process metrology data can be used for feed forward control. In addition, the pre-process metrology data can be verified by comparison to data for a control and/or reference substrate.

During the pre-processing measurement process, an alarm condition can be established. The metrology module can generate and/or receive alarm data and the system controller and/or the metrology module can declare an alarm condition. The metrology module can respond to the alarm by halting one or more software applications, by storing data, by re-running one or more software applications, and/or by attempting to clear one or more alarms.

In one embodiment, the metrology module can filter the measured data during and/or after the pre-processing measurement process. Alternately, data filtering is not required. For example, the metrology module can include an outlier rejection filter that can remove outliers that are statistically not valid. In other words, data that are not reliable can be thrown away and is not considered in the calculations. Business rules can be used in the filtering process to ensure the filtered data is reliable. In addition, business rules can be used to determine how the unfiltered and filtered data is processed. The rules can be used to determine which data is filterable data, which data is outlier data, and which data causes an alarm condition to be established.

In one embodiment, a pre-processing measurement process can be performed for each substrate that is scheduled for supercritical processing. Alternately, a pre-processing measurement process may not be performed for one or more substrates that are scheduled for supercritical processing. For example, test runs or DOE procedures can be performed to evaluate the effectiveness of a supercritical processing recipe. Different measurement strategies can be used, and a pre-processing measurement process may not be required for each substrate. For example, the data in the database, the process recipe, and/or the process model can be updated with data from the first substrate from each lot, with data from the last substrate from each lot, with data from each substrate in a lot, with substrate average data, with lot average data, or with cleaning process data.

During the pre-processing measurement process, the desired process result data can be used. The desired process result data can be metrology data for a processed feature on a patterned substrate. It can be representative of a clean feature when a supercritical cleaning process is performed. In one embodiment, the desired process result data can be CD data and/or sidewall angle data. The desired process result data can be the CD and/or sidewall angle data required for a clean feature. The desired process result data can be applicable to one or more CDs located at one or more locations on a substrate. The position data, size data, and limit data can be provided for each measurement site on the substrate. For example, the measurement sites on the substrate used during the pre-processing measurements are known in advance, and are consistent with the stored data.

The desired process result can be compared to the measured data. When the measured data is less than the desired process result, an error can be declared. When the measured data is approximately equal to the desired process result, a “clean” condition can be declared. When the measured data is greater than the desired process result, a removal amount can be established. The removal amount to be removed during a supercritical cleaning process can be regarded as a process model input if the process model that contains the relationship between removal amount and recipe parameters has been verified.

A process model can represent a verified relationship between a desired result and the process variables needed to achieve the desired result. A supercritical cleaning process model can include process variables such as chamber pressure, flow rate, cleaning chemistry, substrate temperature, rinsing chemistry, process times, the number of push-through steps, the number of decompression cycles, or the number of process cycles, or a combination thereof.

Process models for supercritical cleaning procedures can be linear or non-linear. When a non-linear process can be represented as a combination of some linear processes on some respective limited spaces, a non-linear process can be implemented as some limited linear models with respect to some constraints of each space. In addition, an optimal model can be created for one or more different chamber states, and model optimizer applications can be used to update models based on chamber characteristics that change over time.

The controller can determine an input state for a substrate and the input state can be based on the calculated amount of residue in different parts of the substrate. The metrology module can measure and provide measured data for features at or near the center of the substrate, features at or near the edge of the substrate, and/or features at other locations on the substrate. The features can be isolated and/or nested features.

The controller can compare the measured data to desired process result data to determine the amount of residue in one or more of the features. CD data and/or sidewall angle data can be used to determine a thickness value for sidewall residue and/or bottom surface residue. Equations and/or tables can be used to correlate one set of data with another set of data. In addition, the calculation may comprise a compensation term to correct for different photoresists. A residue amount can be a variable that is calculated at or before run time.

The controller can use the thickness value and the residue type to determine the supercritical cleaning recipe to use. Each substrate can have a different amount of residue, and different cleaning recipes can be used. Alternately, a different recipe may not be required for each substrate. For example, the data in the database, the process recipe, and/or the process model can be updated with data from the previous substrate and corrections can be made on a substrate-to-substrate basis.

In one embodiment, the metrology module can be used to measure damascene structures and the library can include information for damascene grating. Alternately, other structures may be used. The metrology module can be used to measure residues in or on damascene structures when the residues are not transparent in the thickness range of interest. For example, a damascene grating with residue therein can be measured using optical metrology before the substrate is cleaned. Based on this measurement, the CD (critical dimension) and profile of a damascene grating with residue therein can be determined. When the residues are removed from the damascene grating, a cleaned damascene grating can be created. The profile of the cleaned damascene grating can be measured in a post cleaning procedure using optical metrology.

In one embodiment, a residue thickness and/or profile can be determined by subtracting a CD and/or profile of a clean damascene grating from a CD and/or profile of a damascene grating with residue therein. In another embodiment, a residue thickness and/or profile can be determined by subtracting a CD and/or profile of a clean feature (grating) from a CD and/or profile of a feature (grating) with residue therein. Moreover, optical metrology allows rapid, non-destructive measurement of features and/or grating structures. These measurements can be done quickly for each site (several seconds). In addition, multiple sites can be measured, allowing process control.

In one embodiment, the cleaning recipe for an entire lot can be based on the measurements made on the first substrate from the lot. Alternately, a different cleaning recipe can be used for each substrate in a lot. In other embodiments, the cleaning recipe may be based on substrate average data, or lot average data.

In 420, a supercritical process can be performed. After a substrate has been measured by the metrology module, the substrate can be transferred to a supercritical processing system. In one embodiment, the metrology module and the supercritical processing system can be both coupled to a transfer system. The transfer system can include storage and/or alignment elements.

When the substrate is being processed by the supercritical processing system, one or more supercritical processing chambers can be used. For example, a cleaning process, a rinsing process, a drying process, a pre-treatment process, a pore sealing process, a dielectric repair process, or an etching process, or a combination thereof can be performed by the supercritical processing system.

In one embodiment, the same set of supercritical processes is performed on each substrate. Alternately, a different set of supercritical processes may be performed on one or more substrates. In addition, when DOE procedures are performed, one or more parameters in a process recipe can be changed when each substrate is processed.

The supercritical processing system can generate alarm data when a hardware error, a software error, or processing error occurs. The supercritical processing system can receive alarm data. The supercritical processing system can respond to the alarm data by halting one or more software applications, by storing data, by re-setting one or more software applications, by sending a message, and/or by attempting to clear one or more alarms. For example, the controller may recalculate a result.

In one embodiment, the cleaning process can be performed using a supercritical processing system, as described herein. A supercritical cleaning process can include a number of steps and a number of process cycles can be performed. For example, a supercritical cleaning process can include a cleaning step, a rinsing step, a treatment step, or a drying step, or a combination thereof.

The cleaning process can be performed using a procedure as shown in FIG. 3.

Referring to FIGS. 2-3, the substrate 205 to be processed can be placed within the processing chamber 208 and the processing chamber 208 can be sealed. For example, during a supercritical residue removal process, the substrate 205 being processed can comprise semiconductor material, low-k dielectric material, metallic material, and can have process-related residue thereon. The substrate 205, the processing chamber 208, and the other elements in the recirculation loop 215 can be heated to an operational temperature. For example, the operational temperature can range from approximately 40 degrees Celsius to approximately 300 degrees Celsius. In some examples, the temperature can range from approximately 80 degrees Celsius to approximately 150 degrees Celsius.

In addition, the processing chamber 208 and the other elements in the recirculation loop 215 can be pressurized. For example, a supercritical fluid, such as substantially pure CO₂, can be used to pressurize the processing chamber 208 and the other elements in the recirculation loop 215. A pump (not shown), can be used to circulate the supercritical fluid through the processing chamber 208 and the other elements in the recirculation loop 215.

In one embodiment, a supercritical cleaning process can include recirculating the cleaning chemistry through the processing chamber 208. Recirculating the cleaning chemistry over the substrate 205 within the processing chamber 208 can comprise recirculating the cleaning chemistry for a period of time to process and/or remove one or more materials and/or residues from the substrate. The period of time is less than about three minutes. Alternately, the period of time may vary from approximately ten seconds to approximately ten minutes. Furthermore, additional cleaning chemistry and/or supercritical fluid may be provided.

In addition, one or more push-through steps can be performed as a part of the cleaning process. During a push-through step, a new quantity of supercritical carbon dioxide can be fed into the processing chamber 208 and the other elements in the recirculation loop 215, and the supercritical cleaning solution along with the process byproducts suspended or dissolved therein can be displaced from the processing chamber 208 and the other elements in the recirculation loop 215 through the exhaust system 260. In an alternate embodiment, a push-through step is not required during a cleaning step. For example, process byproducts can include photoresist materials and/or residues including oxidized and partially oxidized materials.

One or more process recipes can be performed during a cleaning process. For example, different chemistries, different concentrations, different process conditions, and/or different times can be used in different cleaning process steps.

In one embodiment, after a cleaning process is performed, a supercritical rinsing process can be performed. Alternately, a non-supercritical rinsing process can be performed. For example, a supercritical rinsing process can include recirculating the rinsing chemistry within the processing chamber 208 and/or recirculation loop 215. Recirculating the rinsing chemistry can comprise recirculating the rinsing chemistry for a period of time to process and/or remove one or more materials and/or residues from the substrate 205.

For a cleaning process, the amount of residue to be removed during a process can be regarded as the desired result if a supercritical cleaning process model that contains the relationship between amount of residue removed and recipe parameters has been verified. The supercritical cleaning process model represents the verified relationship between the desired results (clean features) and the supercritical cleaning process variables needed to achieve those results. The supercritical cleaning process model can be formula-based models and/or table-based models. Formula-based models are the continuous association of desired results with recipe variables based on some evaluated experimental data. Table-based models can comprise piecewise associations of desired results with recipe variables based on some evaluated experimental data. A supercritical process model can be linear or non-linear.

After a substrate has been processed by the supercritical processing system, the substrate can be transferred to a metrology module. In one embodiment, the metrology module and the supercritical processing system can be both coupled to a transfer system. The transfer system can include storage and/or alignment elements.

Referring again to FIG. 4, in 430, a post-processing measurement process can be performed. During a post-processing measurement process, a substrate can be measured using optical measurement systems. For example, a metrology module can use ODP™ techniques to obtain measured data for features on a patterned substrate after the substrate has been processed by a supercritical processing system, and ODP™ techniques can be used to measure the presence and/or thickness of coatings and/or residues within features of a patterned substrate.

During a post-processing measurement process, a substrate can be positioned on a holder in a chamber in a metrology module. In one embodiment, the substrate can be aligned before being positioned in the measurement module. Alternately, pre-alignment of the substrate is not required. For example, a substrate can be aligned in the metrology module.

During a post-processing measurement process, the effectiveness of the cleaning operation can be determined. This thickness information can be used to determine the recipe parameters to use during the cleaning operation.

Before, during, and/or after a post-processing measurement process, the controller can receive data, process data, store data, and/or send data. The data can include input data, output data, process data, historical data, tool/chamber data, and alarm data. For example, the historical data can also include pre-process metrology data, post-process metrology data, site measurement data, and/or substrate data. In addition, the metrology module can use rules data from a higher-level system when verifying and/or processing data. The metrology module can generate alarm data when data is not received and/or not verified. For example, the metrology module may request a data sender to resend the data.

During the post-processing measurement process, post-process metrology data can be created by the metrology module, and the post-process metrology data can include site measurement data and substrate data. Post-process metrology data can be used for feed back control. In addition, the post-process metrology data can be compared to data for a control and/or reference substrate according to some business rules.

During the post-processing measurement process, an alarm condition can be established. The metrology module can generate and/or receive alarm data and the system controller and/or the metrology module declare an alarm condition. The metrology module can respond to the alarm by halting one or more software applications, by storing data, by re-running one or more software applications, and/or by attempting to clear one or more alarms.

In one embodiment, the metrology module can filter the measured data during and/or after the post-processing measurement process. Alternately, data filtering is not required. For example, the metrology module can include an outlier rejection filter that can remove outliers that are statistically not valid. In other words, data that are not reliable can be thrown away and is not considered in the calculations. Business rules can be used in the filtering process to ensure the filtered data is reliable. In addition, business rules can be used to determine how the unfiltered and filtered data is processed. The rules can be used to determine which data is filterable data, which data is outlier data, and which data causes an alarm condition to be established.

In one embodiment, a post-processing measurement process can be performed for each substrate that was processed in the supercritical processing system. Alternately, a post-processing measurement process may not be performed for one or more substrates that were processed in the supercritical processing system. For example, test runs or DOE procedures can be performed to evaluate the effectiveness of a supercritical processing recipe. Different measurement strategies can be used, and a post-processing measurement step may not be required for each substrate. For example, the data in the database, the process recipe, and/or the process model can be updated with the post-process metrology data from the first substrate from each lot, with post-process metrology data from each substrate in a lot, with substrate average data, with lot average data, or with other process data.

During the post-processing measurement process, the desired process result data can be used. The desired process result data can be metrology data for a processed feature on a patterned substrate. It can be representative of a clean feature when a supercritical cleaning process is performed. In one embodiment, the desired process result data can be CD data and/or sidewall angle data. The desired process result data can be the CD and/or sidewall angle data required for a clean feature. The desired process result data can be applicable to one or more CDs located at one or more locations on a substrate. The position data, size data, and limit data can be provided for each measurement site on the substrate. For example, the measurement sites on the substrate used in the post-processing measurements are known in advance, and are consistent with the stored data.

The controller can determine an output and/or processed state for a substrate and the output and/or processed state can be based on the data from grating patterns located at different location on the substrate. The metrology module can measure and provide measured data for features at or near the center of the substrate, features at or near the edge of the substrate, and/or features at other locations on the substrate. The features can be isolated and/or nested features. CD data and/or sidewall angle data can be used to determine an output and/or processed state.

In 440, the post-processing metrology data can be compared to the pre-processing metrology data to determine if the cleaning process has been performed correctly. Alternately, the post-processing metrology data can be compared to the data for a reference substrate and/or historical data to determine if the cleaning process has been performed correctly.

During the comparison step, desired process result data can be used. The desired process result data can be metrology data for a processed feature on a patterned substrate. In one embodiment, the desired process result data can be the measurement data required for a clean feature or the desired measurement data for a treated feature. The desired process result data can be applicable to one or more features located at one or more locations on a substrate. The measurement data can include CD data, sidewall angle data, position data, layer data, and composition data for each measurement site on the substrate. For example, substrates can have 0.25 micron and smaller features.

The controller can compare the post-processing measured data to desired process result data to determine if the substrate has been processed correctly. For example, the controller can determine if a substrate has been cleaned correctly when the post-processing measurement process is performed after a supercritical cleaning process. When the post-processing metrology data is less than the desired process result, an alarm condition can be established. When the post-processing metrology data is approximately equal to the desired process result, a “clean” condition can be declared. When the post-processing metrology data is greater than the desired process result, a second type of alarm can be established. For example, when the second type of alarm is established, the system controller can determine if another cleaning operation is required. Alternately, the controller can determine if a substrate has been treated correctly when the post-processing measurement process is performed after a supercritical treatment process.

In addition, the system controller can determine that the substrate was not processed correctly and can send the substrate to another supercritical processing chamber for further processing. The metrology module can perform non-destructive testing, and substrates do not have to be removed from a process lot to have destructive testing, such as CD SEM measurements, performed.

In 495, procedure 400 can end. After a residue removal process has been performed, a k-value restoration process, or a pore sealing process, or a combination process can be performed.

During a DOE process, post-processing measurements can be made after cleaning steps, rinsing steps, drying steps, and/or treatment steps to determine the effectiveness of these types of processing. For example, different supercritical processing recipes can be optimized using pre- and post-processing measurement processes.

In one example of the present invention, a substrate having a patterned low-k layer thereon is positioned in a metrology chamber, and the residue within at least one feature on the substrate is measured. Based upon this measurement, a supercritical cleaning process recipe is determined, which may include, for example, the chemistry of the supercritical fluid, the flow rate of the fluid, the chamber pressure and temperature, and/or the time for circulating the fluid. The substrate is then transferred from the metrology chamber and positioned in a supercritical process chamber where it is cleaned with a supercritical fluid using the determined supercritical cleaning process recipe.

In one further example of the present invention, after cleaning the substrate, the substrate is removed from the supercritical process chamber and re-positioned in the metrology chamber, where at least one feature is analyzed to measure any residue that may remain in the feature. If the measurement is substantially zero, then the substrate may be identified as properly cleaned and/or the process recipe may be stored for use in processing subsequent substrates. If the measurement is not substantially zero, then the substrate may be identified as not properly cleaned, and/or a new or revised supercritical cleaning process recipe may be determined for use in processing subsequent substrates, and/or a new process recipe may be determine for further processing of the present substrate. Thus, metrology data may be used before and after supercritical cleaning of each substrate to determine if the process recipe is effective to properly clean the substrates, and to adjust the recipe when it is not effective.

In an alternative further example of the present invention, after cleaning the substrate, the substrate is removed from the supercritical process chamber and the cleaning process is repeated for a desired number N of additional substrates using the determined supercritical cleaning process recipe. For example, the process may be repeated for an entire lot of substrates. In a further example, n may be greater than 1, and up to 25. After cleaning the desired number N of additional substrates, the N^{th} additional substrate is removed from the supercritical process chamber and positioned in the metrology chamber, where at least one feature is analyzed to measure any residue that may remain in the feature. If the measurement is substantially zero, then the lot (or group of additional substrates) may be identified as properly cleaned and/or the process recipe may be stored for use in processing subsequent substrates or lots. If the measurement is not substantially zero, then the lot (or group of additional substrates) may be identified as not properly cleaned, and/or a new or revised supercritical cleaning process recipe may be determined for use in processing subsequent substrates or lots, and/or a new process recipe may be determine for further processing of the present lot (or group of additional substrates). Thus, metrology data may be used before supercritical cleaning of the first substrate in a group of substrates and after supercritical cleaning of the last substrate in the group of substrates to determine if the process recipe is effective to properly clean the desired number of substrates, and to adjust the recipe when it is not effective before the next group are processed.

While the invention has been described in terms of specific embodiments incorporating details to facilitate the understanding of the principles of construction and operation of the invention, such reference herein to specific embodiments and details thereof is not intended to limit the scope of the claims appended hereto. It will be apparent to those skilled in the art that modifications may be made in the embodiments chosen for illustration without departing from the scope of the invention.

What is claimed is:

1. A method of processing a substrate having a patterned low-k layer thereon, the method comprising the steps of:
a) positioning the substrate on a first substrate holder in a metrology chamber;
b) measuring a residue in at least one feature of the substrate;
c) determining a supercritical cleaning process recipe based on the measured residue;
d) positioning the substrate on a second substrate holder in a supercritical processing chamber coupled to the metrology chamber;
e) cleaning the substrate with a supercritical fluid using the determined supercritical cleaning process recipe; and
f) removing the substrate from the supercritical processing chamber.

2. The method of claim 1, further comprising:
g) re-positioning the substrate in the metrology chamber; and
h) measuring any remaining residue in at least one feature of the substrate.

3. The method of claim 2, further comprising:
i) storing the determined supercritical cleaning process recipe when the measured remaining residue is substantially equal to zero; and
j) determining a new supercritical cleaning process recipe when the measured remaining residue is not substantially equal to zero.

4. The method of claim 2, further comprising:
i) identifying the substrate as a cleaned substrate when the measured remaining residue is substantially equal to zero; and
j) identifying the substrate as an un-cleaned substrate when the measured remaining residue is not substantially equal to zero.

5. The method of claim 1, further comprising:
g) positioning an additional substrate on the second substrate holder in the supercritical processing chamber;
h) cleaning the additional substrate with the supercritical fluid using the determined supercritical cleaning process recipe;
i) removing the additional substrate from the supercritical processing chamber;
j) repeating steps g)-i) (N−1) times, where N is an integer greater than one and less than or equal to twenty five;
k) re-positioning the N^{th} substrate in the metrology chamber; and
l) measuring any remaining residue in at least one feature of the N^{th} substrate.

6. The method of claim 5, further comprising:
m) storing the determined supercritical cleaning process recipe when the measured remaining residue is substantially equal to zero; and
n) determining a new supercritical cleaning process recipe when the measured remaining residue is not substantially equal to zero.

7. The method of claim 5, further comprising:
m) identifying the N^{th} substrate as a cleaned substrate when the measured remaining residue is substantially equal to zero; and
n) identifying the N^{th} substrate as an un-cleaned substrate when the measured remaining residue is not substantially equal to zero.

8. The method of claim 1, wherein a transfer system couples the supercritical processing chamber to the metrology chamber.

9. The method of claim 1, wherein the substrate comprises semiconductor material, metallic material, dielectric material, or ceramic material, or a combination of two or more thereof.

10. The method of claim 9, wherein the substrate comprises a low-k dielectric material, or an ultra low-k dielectric material, or a combination thereof.

11. The method of claim 1, wherein the supercritical fluid according to the determined supercritical cleaning process recipe comprises supercritical CO₂ and a cleaning chemistry.

12. The method of claim 11, wherein the cleaning chemistry comprises an acid and a solvent.

13. The method of claim 11, further comprising in step e):
pressurizing the supercritical processing chamber to a first cleaning pressure;
introducing the supercritical fluid into the supercritical processing chamber; and
recirculating the supercritical fluid through the supercritical processing chamber for a first period of time.

14. The method of claim 13, wherein the first period of time is in a range of thirty seconds to ten minutes.

15. The method of claim 13, further comprising after the first period of time:
performing a push-through process wherein the supercritical processing chamber is pressurized to a supercritical pressure; and
venting the supercritical processing chamber to push the process chemistry out of the supercritical processing chamber after recirculating the supercritical fluid.

16. The method of claim 15, further comprising performing a rinsing process, wherein the substrate is rinsed using a supercritical rinsing fluid comprising supercritical CO₂ and a rinsing chemistry, wherein the rinsing chemistry comprises an alcohol.

17. A computer-readable medium comprising computer-executable instructions for:
positioning a substrate on a first substrate holder in a metrology chamber;
measuring a residue in at least one feature of the substrate;
determining a supercritical cleaning process recipe based on the measured residue;
positioning the substrate on a second substrate holder in a supercritical processing chamber coupled to the metrology chamber;
cleaning the substrate with a supercritical fluid using the determined supercritical cleaning process recipe; and
removing the substrate from the supercritical processing chamber.

18. The computer-readable medium of claim 17, further comprising computer-executable instructions for:
re-positioning the substrate in the metrology chamber; and
measuring any remaining residue in at least one feature of the substrate.

19. A method of operating a controller in a processing system configured to process a substrate, the method comprising the steps of:
instructing the processing system to position the substrate on a first substrate holder in a metrology chamber;
instructing the processing system to measure a residue in at least one feature of the substrate;
instructing the processing system to determine a supercritical cleaning process recipe based on the measured residue;
instructing the processing system to position the substrate on a second substrate holder in a supercritical processing chamber coupled to the metrology chamber;
instructing the processing system to clean the substrate with the supercritical fluid using the determined supercritical cleaning process recipe; and
instructing the processing system to remove the substrate from the supercritical processing chamber.

20. The method of claim 19, further comprising:
instructing the processing system to re-position the substrate in the metrology chamber; and
instructing the processing system to measure a remaining residue in at least one feature of the substrate.
